(19) United States
(12) Patent Application Publication
(10) Pub. No.: US 2026/0318732 A1
(43) Pub. Date: Oct. 15, 2026

(54) PHOTOELECTRIC MEASURMENT APPARATUS AND TEMPERATURE CONTROL DEVICE

(71) Applicant: LITE-ON TECHNOLOGY CORPORATION, TAIPEI CITY (TW)

(72) Inventors: YAN-YI WANG, NEW TAIPEI CITY (TW); YU-KANG LU, Taipei City (TW); JYUN-SING WU, TAIPEI CITY (TW); Hung-Pin Chou, TAIPEI CITY (TW)

(21) Appl. No.: 19/466,532

(22) Filed: Feb. 2, 2026

Related U.S. Application Data
(60) Provisional application No. 63/768,179, filed on Mar. 7, 2025.

(30) Foreign Application Priority Data
Nov. 12, 2025 (CN) 202511652247.6

(51) Int. Cl. G01J 1/02; G01J 1/04; G01J 1/44

(52) U.S. Cl. CPC G01J 1/0228; G01J 1/0425; G01J 1/44

(57) ABSTRACT

A temperature control device includes an environment simulation chamber, a thermal conduction seat arranged in the environment simulation chamber, and an anti-condensation chamber covering and not in spatial communication with the environment simulation chamber. The environment simulation chamber is configured to allow a cold air having temperature lower than 15℃ to travel therein so as to simulate a low-temperature environment. The thermal conduction seat has a carrying surface configured to allow a device under test (DUT) to be disposed thereon so as to be located outside of the environment simulation chamber. The anti-condensation chamber is configured to allow the DUT on the carrying surface to be located therein, and includes a housing segment and a light-permeable segment connected to the housing segment. The thermal conduction seat is arranged in a space surroundingly defined by the housing segment. The light-permeable segment is in spatial communication with the housing segment.

### CROSS-REFERENCE TO RELATED PATENT APPLICATION

This application claims the benefit of priority to China Patent Application No. 202511652247.6, filed on November 12, 2025, in the People’s Republic of China. The entire content of the above identified application is incorporated herein by reference.

This application claims the benefit of priority to the U.S. Provisional Patent Application Ser. No. 63/768,179, filed on March 7, 2025, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a temperature control device, and more particularly to a photoelectric measurement apparatus and a temperature control device each having an anti-condensation function.

### BACKGROUND OF THE DISCLOSURE

A conventional measurement device is easily affected by high or low-temperature environments. For example, when the conventional measurement device is operated in a low-temperature environment, moisture in the air often condenses on a surface of a device under test (DUT), thus affecting the measurement results.

### SUMMARY OF THE DISCLOSURE

In response to the above-referenced technical inadequacies, the present disclosure provides a photoelectric measurement apparatus and a temperature control device for effectively improving on the issues associated with conventional measurement devices.

In order to solve the above-mentioned problems, one of the technical aspects adopted by the present disclosure is to provide a temperature control device, which includes an environment simulation chamber, a thermal conduction seat, and an anti-condensation chamber. The environment simulation chamber is configured to allow a cold air having temperature lower than 15 ℃ or a hot air having temperature higher than 35℃ to travel therein so as to simulate a low-temperature environment or a high-temperature environment. The thermal conduction seat is arranged in the environment simulation chamber and has a carrying surface that is configured to allow a device under test (DUT) to be disposed thereon so as to be located in the environment simulation chamber. The anti-condensation chamber is configured to allow a dry air to travel therein. The environment simulation chamber is covered by and is not in spatial communication with the anti-condensation chamber. The anti-condensation chamber includes a housing segment and a light-permeable segment. The thermal conduction seat is arranged in a space surroundingly defined by the housing segment. The light-permeable segment is in spatial communication with the housing segment and has an outer light-permeable layer and an inner light-permeable layer that is spaced apart from the outer light-permeable layer. Each of the outer light-permeable layer and the inner light-permeable layer has a spherical shape having a center of sphere that is located on the carrying surface.

Therefore, any one of the temperature control device and the photoelectric measurement apparatus of the present disclosure is provided with the structural design and the cooperation of the environment simulation chamber, the thermal conduction seat, and the anti-condensation chamber, so that the anti-condensation chamber can effectively prevent water vapor from condensing in a light source path of the DUT, thereby allowing the energy of the light source emitted by the DUT to pass through the light-permeable segment for accurate measurement. In addition, the structural configuration of any one of the temperature control device and the photoelectric measurement apparatus also facilitates accurate measurement results in high-temperature environments.

These and other aspects of the present disclosure will become apparent from the following description of the embodiment taken in conjunction with the following drawings and their captions, although variations and modifications therein may be effected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a photoelectric measurement apparatus being a total luminous flux measurement apparatus according to a first embodiment of the present disclosure;

FIG. 2 is a schematic view of the photoelectric measurement apparatus being a light intensity measurement apparatus according to the first embodiment of the present disclosure;

FIG. 3 is a schematic view of the photoelectric measurement apparatus being a goniometer systems measurement apparatus according to the first embodiment of the present disclosure;

FIG. 4 is a schematic perspective view of a temperature control device according to the first embodiment of the present disclosure;

FIG. 5 is a schematic exploded view of FIG. 4;

FIG. 6 is a schematic cross-sectional view taken along line VI-VI of FIG. 4;

FIG. 7 is a schematic cross-sectional view showing the temperature control device in another configuration according to the first embodiment of the present disclosure;

FIG. 8 is a schematic cross-sectional view of the temperature control device according to a second embodiment of the present disclosure;

FIG. 9 is a schematic cross-sectional view of the temperature control device in another configuration according to the second embodiment of the present disclosure;

FIG. 10 is a schematic cross-sectional view of the temperature control device according to a third embodiment of the present disclosure;

FIG. 11 is a schematic exploded view of FIG. 10;

FIG. 12 is a schematic cross-sectional view taken along line XII-XII of FIG. 10;

FIG. 13 is a schematic cross-sectional view of the temperature control device in another configuration according to the third embodiment of the present disclosure;

FIG. 14 is a schematic cross-sectional view of the temperature control device according to a fourth embodiment of the present disclosure; and

FIG. 15 is a schematic cross-sectional view of the temperature control device in another configuration according to the fourth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way.

Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

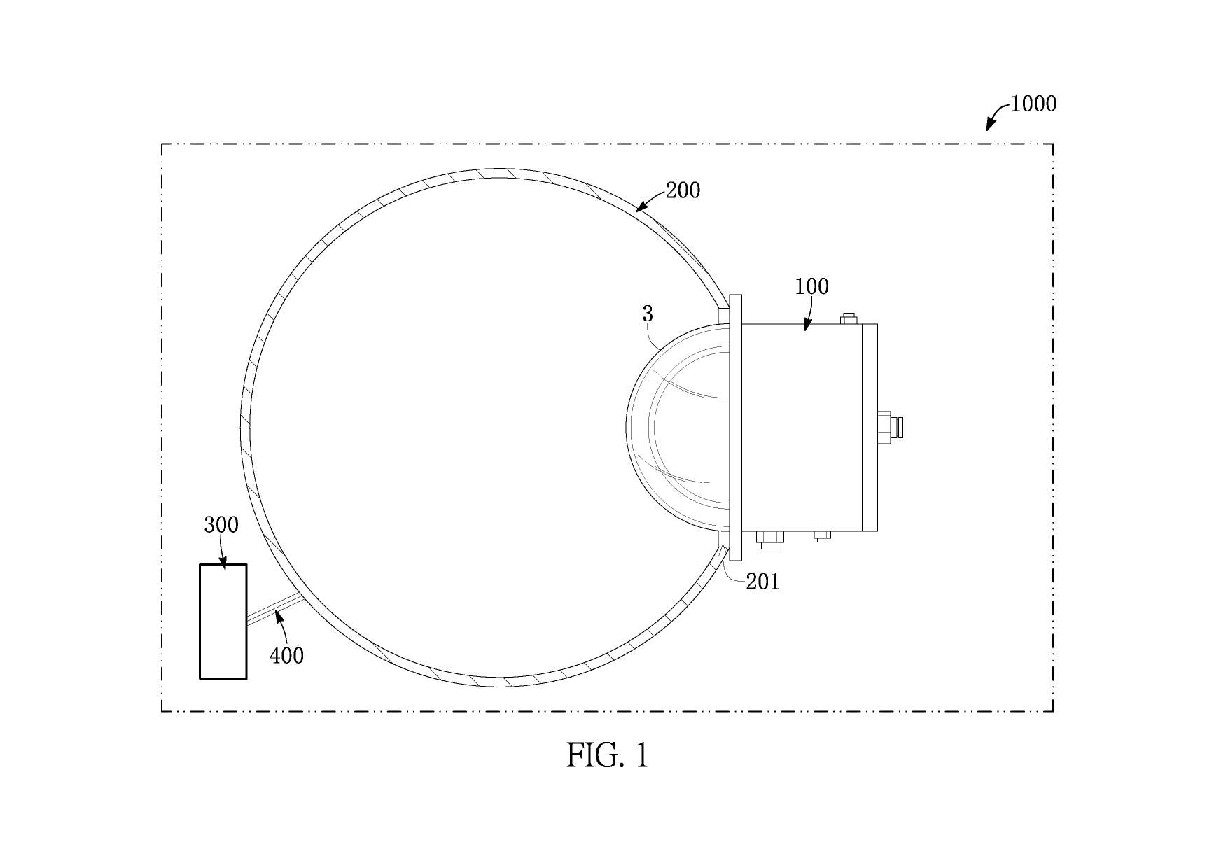

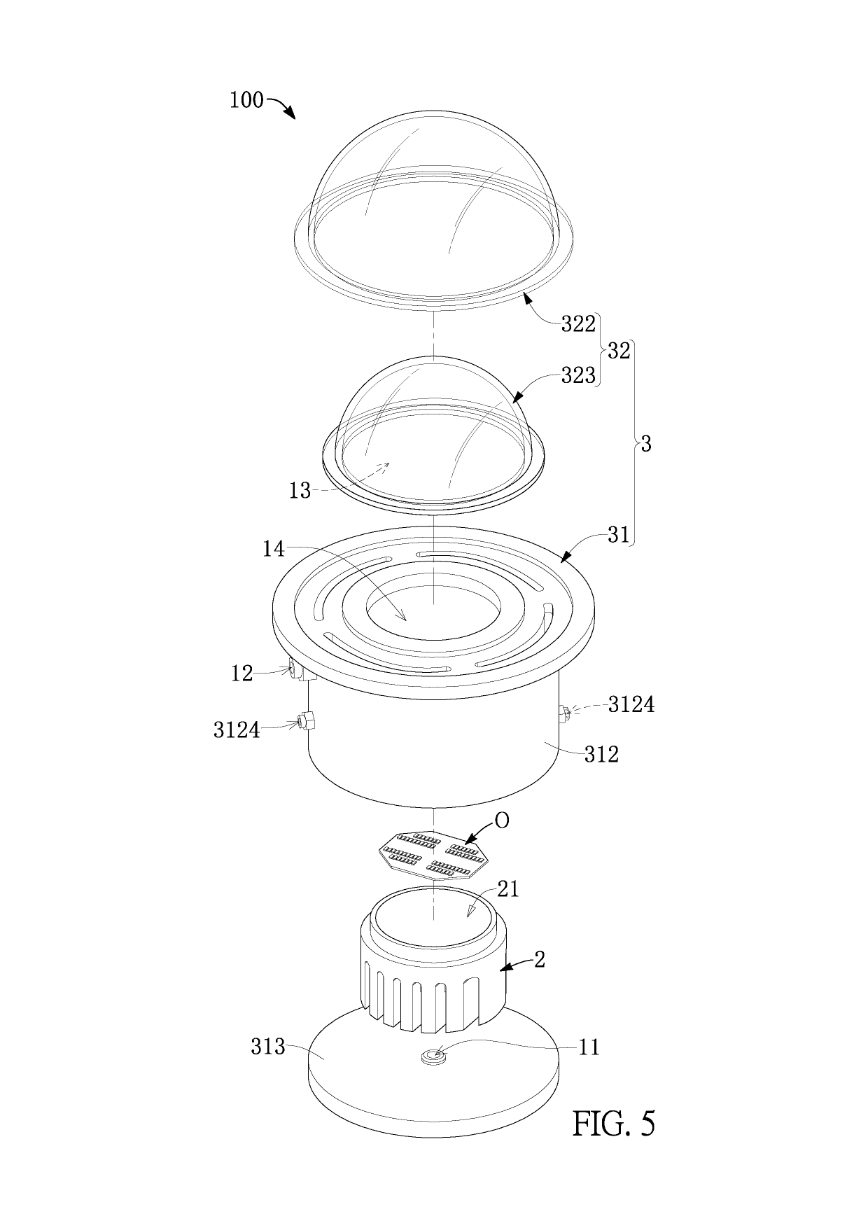

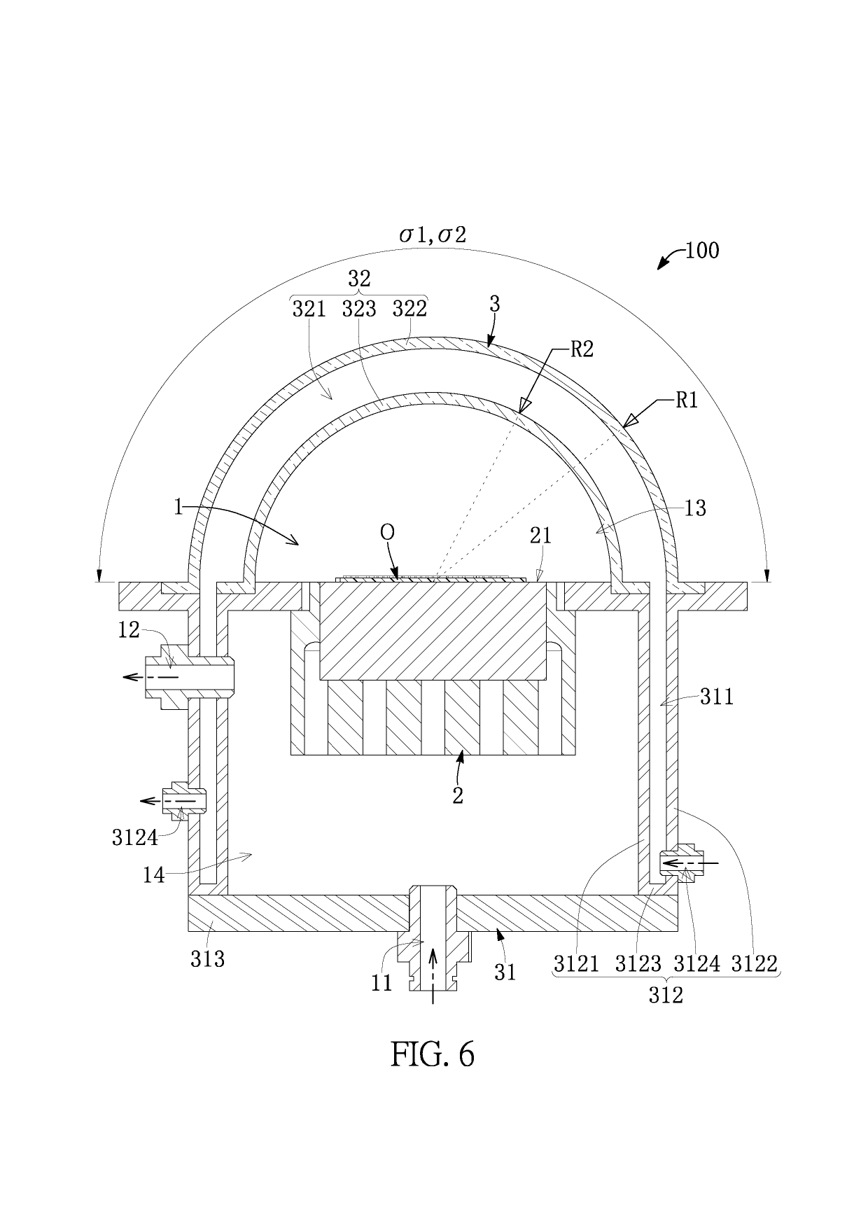

Referring to FIGS. 1 to FIG. 7, a first embodiment of the present disclosure is provided. As shown in FIGS. 1 to FIG. 3, the present embodiment provides a temperature control device 100, which can be applied to a photoelectric measurement apparatus 1000. The photoelectric measurement apparatus 1000 can be a total luminous flux measurement apparatus (as shown in FIG. 1), which includes an integral ball 200, a measurement device 300, and an optical fiber 400 that is connected to the integral ball 200 and the measurement device 300. The integral ball 200 has an opening 201, and a part of the temperature control device 100 (e.g., a part of an anti-condensation chamber 3 as disclosed in the following description) is inserted into the integral ball 200 through the opening 201.

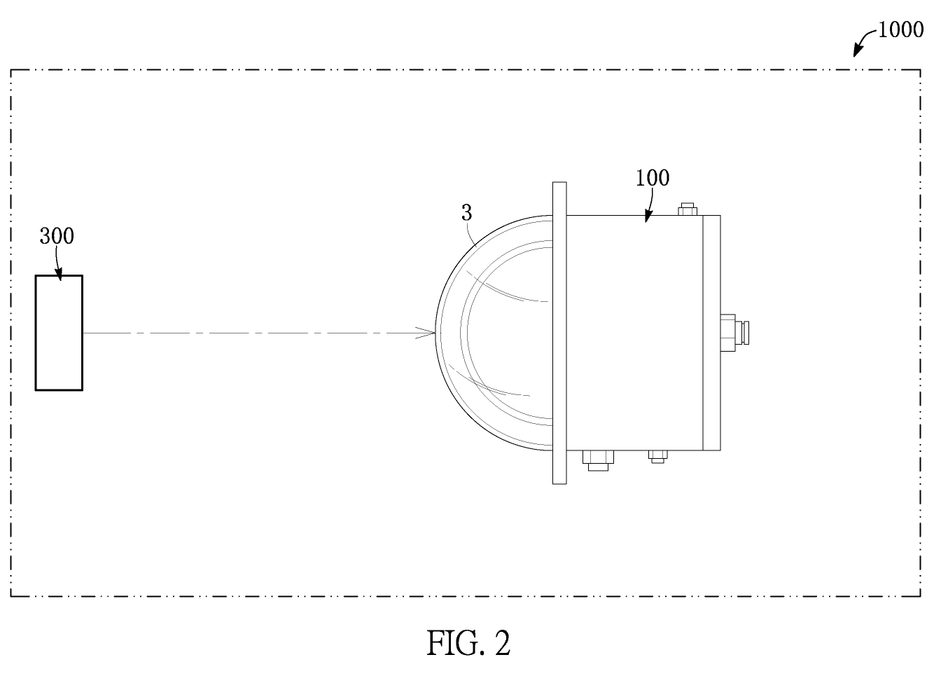

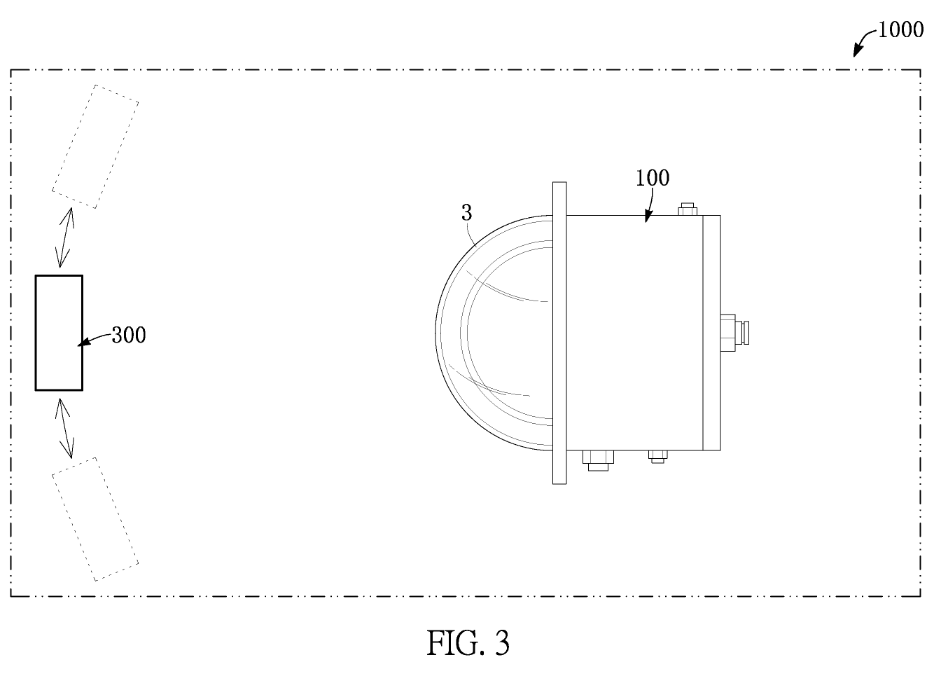

Moreover, the photoelectric measurement apparatus 1000 can be provided in another configuration according to practical requirements. For example, the photoelectric measurement apparatus 1000 can be a light intensity measurement apparatus (as shown in FIG. 2) or a goniometer systems measurement apparatus (as shown in FIG. 3), but the present disclosure is not limited thereto. In other words, in other embodiments of the present disclosure not shown in the drawings, the temperature control device 100 can be independently used (e.g., sold) or can be used in cooperation with other components.

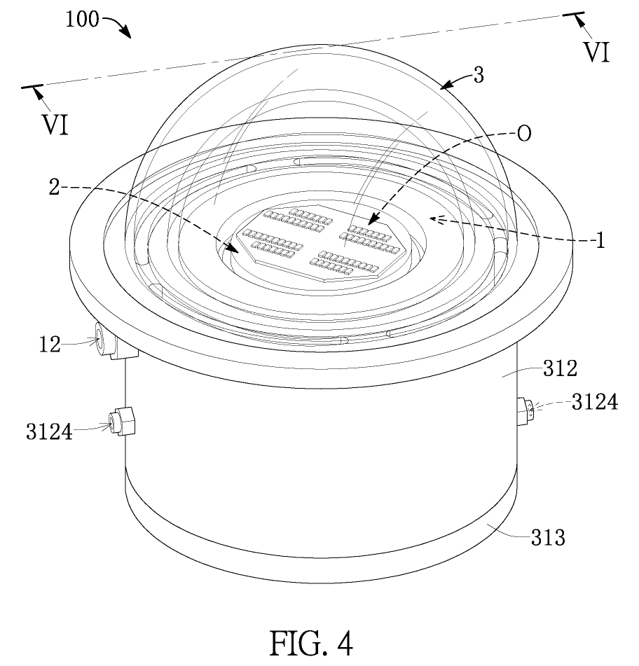

As shown in FIGS. 4 to FIG. 6, the temperature control device 100 of the present embodiment includes an environment simulation chamber 1, a thermal conduction seat 2 arranged in the environment simulation chamber 1, and an anti-condensation chamber 3 that covers and is not in spatial communication with the environment simulation chamber 1. It should be noted that the environment simulation chamber 1 in the present embodiment includes a first chamber 13 and a second chamber 14 that is in spatial communication with the first chamber 13. So, the second chamber 14 and the first chamber 13 are connected to form a convection loop. The temperature control device 100 (i.e., the environment simulation chamber 1, the thermal conduction seat 2, and the anti-condensation chamber 3) can be provided in different configurations according to practical requirements, and the following description describes one of the different configurations for clearly understanding the present embodiment, but the present disclosure is not limited thereto.

The environment simulation chamber 1 is configured to allow a cold air having temperature lower than 15℃ to travel therein so as to simulate a low-temperature environment. The temperature of the cold air can be within a range from -45℃ to -15℃, and can be as low as -55℃. In other words, the cold air is preferably a dry air with low water vapor content (or low relative humidity), and the low temperature environment is equivalent to a testing environment where a device under test (DUT) O is located. The cold air has a dew point temperature that is preferably lower than its temperature and that conforms to the specifications of CLASS 2 or CLASS 1 of ISO 8573-1:2010, but the present disclosure is not limited thereto.

Specifically, the DUT O of the present embodiment is applied to a matrix LED array of an adaptive driving beam (ADB), and the temperature of the cold air can be adjusted or changed according to the testing environment of the DUT O (e.g., the temperature of the cold air can be lower than 0℃), but the present disclosure is not limited thereto. In addition, according to practical requirements, the environment simulation chamber 1 can be configured to allow a hot air having temperature higher than 35℃ to travel therein so as to simulate a high-temperature environment; for example, the temperature of the hot air has a critical value less than or equal to 225℃ and is preferably within a range from 50℃ to 105℃.

Moreover, the environment simulation chamber 1 of the present embodiment has an enter channel 11 and an exit channel 12. The cold air enters the environment simulation chamber 1 through the enter channel 11 and is discharged from the environment simulation chamber 1 through the exit channel 12. The enter channel 11 is arranged away from the thermal conduction seat 2 to facilitate formation of the low-temperature environment, and the exit channel 12 is arranged adjacent to the thermal conduction seat 2 to facilitate maintaining of the low-temperature environment. It should be noted that the enter channel 11 and the exit channel 12 in the present embodiment are in spatial communication with the second chamber 14, and the cold air (or the hot air) can flow into the first chamber 13 through conductive vias (not labeled in the drawings) of the thermal conduction seat 2, but the present disclosure is not limited thereto.

The thermal conduction seat 2 is arranged in the environment simulation chamber 1 and has a heat transfer coefficient being greater than or equal to 10W/m•k. For example, the thermal conduction seat 2 can be made of at least one of copper, aluminum, iron, steel, gold, and silver according to practical requirements, but the present disclosure is not limited thereto.

Specifically, the thermal conduction seat 2 has a carrying surface 21 arranged on one end thereof. The carrying surface 21 is configured to allow the DUT O to be disposed thereon so as to be located in the environment simulation chamber 1 (e.g., the first chamber 13). Furthermore, the thermal conduction seat 2 has a heat-dissipation portion 22 such as heat-dissipation fins shown in the drawings. In the present embodiment, the carrying surface 21 can be flat and is not located at a path defined by extending the enter channel 11 for preventing the carrying surface 21 (and the DUT O disposed thereon) from directly contacting the cold air in the environment simulation chamber 1, thereby avoiding affecting subsequent related measurement results. In other words, the cold air entering the environment simulation chamber 1 through the enter channel 11 does not directly flow to the DUT O, and the cold air is directly in contact with the carrying surface 21 and the DUT O through convection of the cold air.

The anti-condensation chamber 3 is configured to allow a dry air to travel therein, thereby effectively avoiding condensation of dew. In the present embodiment, the anti-condensation chamber 3 is configured to allow the dry air having a dew point temperature within a range from -130℃ to 10℃ to travel therein, and the dry air can have a normal temperature (e.g., 15℃ to 30℃), but the present disclosure is not limited thereto.

Specifically, the environment simulation chamber 1 in the present embodiment is defined by the anti-condensation chamber 3, and the thermal conduction seat 2 is arranged in the environment simulation chamber 1 by being assembled to the anti-condensation chamber 3. In order to clearly describe the present embodiment, the following description further describes one specific structure of the anti-condensation chamber 3 that can be provided to implement the one of the different configurations, but the present disclosure is not limited thereto.

In the present embodiment, the anti-condensation chamber 3 includes a housing segment 31 and a light-permeable segment 32 that is in spatial communication with the housing segment 31. In other words, each of the housing segment 31 and the light-permeable segment 32 is substantially in a hollow shape, and an inner space 311 of the housing segment 31 and an inner space 321 of the light-permeable segment 32 are in spatial communication with each other for allowing the dry air to travel therein.

Specifically, an inner side of the light-permeable segment 32 and an inner side of the housing segment 31 jointly define the environment simulation chamber 1 (e.g., the inner space 311 of the housing segment 31 and the inner space 321 of the light-permeable segment 32 are not in a spatial communication with the environment simulation chamber 1), the enter channel 11 and the exit channel 12 are arranged on the housing segment 31, and the thermal conduction seat 2 is arranged in a space surroundingly defined by the housing segment 31 (i.e., the thermal conduction seat 2 is arranged in a part of the environment simulation chamber 1), but the present disclosure is not limited thereto.

In the present embodiment, the housing segment 31 includes an annular wall 312 and a bottom base 313 that is fixed to and closes one end of the annular wall 312.

The annular wall 312 defines the inner space 311, and another end of the annular wall 312 is connected to the light-permeable segment 32. In other words, the annular wall 312 has an inner wall 3121, an outer wall 3122 surrounding and being spaced apart from the inner wall 3121, and an end wall 3123. The end wall 3123 is connected to one end of the inner wall 3121 and the outer wall 3122 so as to jointly define the inner space 311 having a slot shape, and an opening of the inner space 311 is arranged on another end of the inner wall 3121 and the outer wall 3122. Moreover, the annular wall 312 (e.g., the outer wall 3122) has two entrances 3124 arranged away from each other for providing inflow and outflow of the dry air.

In addition, the enter channel 11 of the environment simulation chamber 1 is formed on (e.g., penetrates through) the bottom base 313, and the exit channel 12 is formed on (e.g., penetrates through) the inner wall 3121 and the outer wall 3122 of the annular wall 312.

It should be noted that the housing segment 31 (e.g., the annular wall 312) and the light-permeable segment 32 of the present embodiment are detachable from each other, but the present disclosure is not limited thereto. For example, in other embodiments of the present disclosure not shown in the drawings, the light-permeable segment 32 can be non-detachably fixed to the housing segment 31 according to practical requirements.

In the present embodiment, the light-permeable segment 32 includes an outer light-permeable layer 322 and an inner light-permeable layer 323 that is spaced apart from the outer light-permeable layer 322 and the carrying surface 21. Each of the outer light-permeable layer 322 and the inner light-permeable layer 323 has a light transmittance within a range from 85% to 95% relative to light that has a wavelength within a range from 400 nm to 700 nm. For example, the outer light-permeable layer 322 and/or the inner light-permeable layer 323 can be made of glass (e.g., optical glass or quartz glass) or sapphire.

Specifically, in order to enable the light-permeable segment 32 to have better performance, the outer light-permeable layer 322 and the inner light-permeable layer 323 can have at least part of the following features. Each of the outer light-permeable layer 322 and the inner light-permeable layer 323 has a spherical shape having a center of sphere that is located on the carrying surface 21. Moreover, in a cross section of the light-permeable segment 32, the outer light-permeable layer 322 has a first radius R1, the inner light-permeable layer 323 has a second radius R2 that is less than or equal to 62% of the first radius R1, the outer light-permeable layer 322 has a first central angle σ1 being within a range from 0 degrees to 180 degrees, and the inner light-permeable layer 323 has a second central angle σ2 that is greater than or equal to the first central angle σ1, but the present disclosure is not limited thereto.

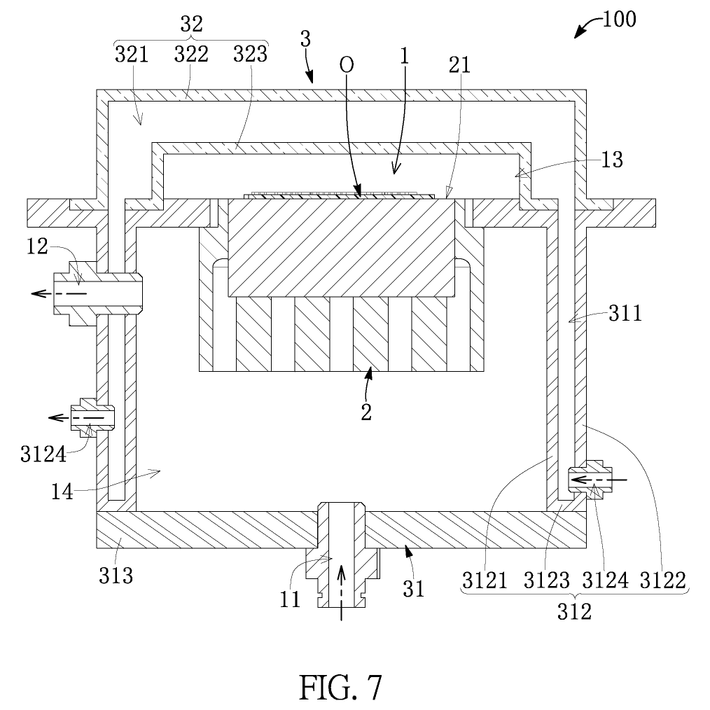

It should be noted that the light-permeable segment 32 shown in FIGS. 4 to FIG. 6 of the present embodiment is substantially a hemispherical structure, but the specific structure of the light-permeable segment 32 can be adjusted or changed according to practical requirements. For example, as shown in FIG. 7, the light-permeable segment 32 can have a flat structure; in other words, each of the outer light-permeable layer 322 and the inner light-permeable layer 323 has a flat layer structure.

In summary, the temperature control device 100 (or the photoelectric measurement apparatus 1000) of the present embodiment is provided with the structural design and the cooperation of the environment simulation chamber 1, the thermal conduction seat 2, and the anti-condensation chamber 3, so that the anti-condensation chamber 3 can effectively prevent water vapor from condensing in a light source path of the DUT O, thereby allowing the energy of the light source emitted by the DUT O to pass through the light-permeable segment 32 for accurate measurement.

### Second Embodiment

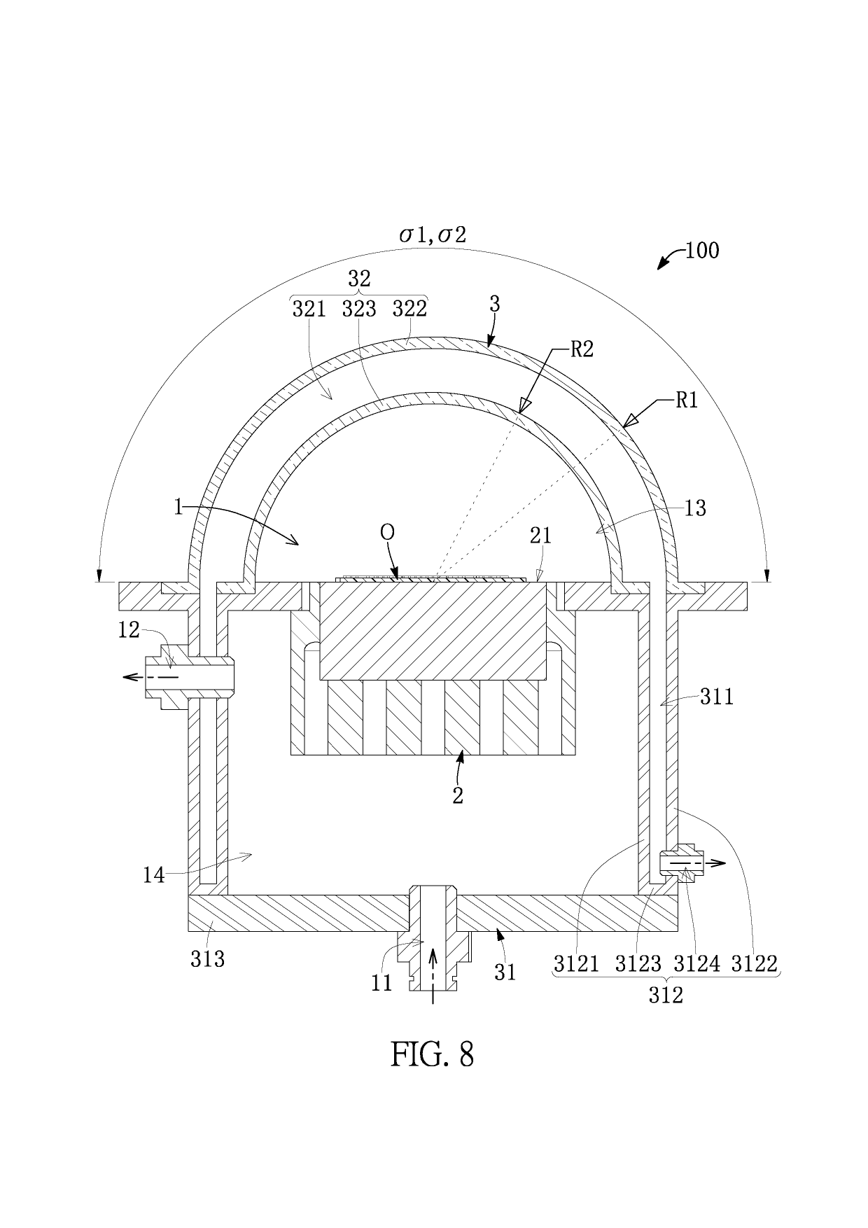

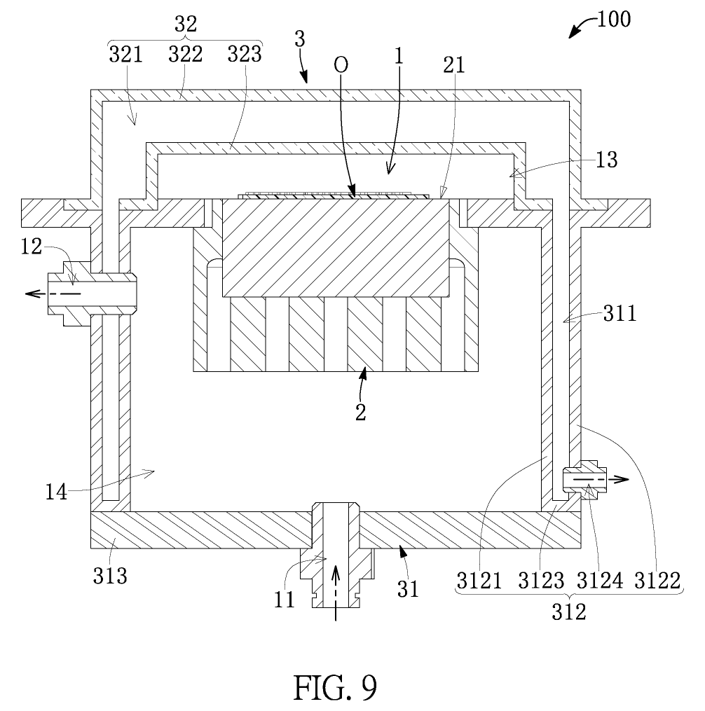

Referring to FIG. 8 and FIG. 9, a second embodiment of the present disclosure, which is similar to the first embodiment of the present disclosure, is provided. For the sake of brevity, descriptions of the same components in the first and second embodiments of the present disclosure will be omitted herein, and the following description only discloses different features between the first and second embodiments.

In the present embodiment, the anti-condensation chamber 3 is in a vacuum mode (e.g., the anti-condensation chamber 3 having a pressure within a range from 10e-12 MPa~10e-5 MPa), thereby achieving an anti-condensation function. Specifically, the annular wall 312 (e.g., the outer wall 3122) can be formed with an entrance 3124 for suction of the anti-condensation chamber 3 (e.g., the inner space 311 of the housing segment 31 and the inner space 321 of the light-permeable segment 32) therefrom, thereby meeting a vacuum requirement of the anti-condensation chamber 3.

### Third Embodiment

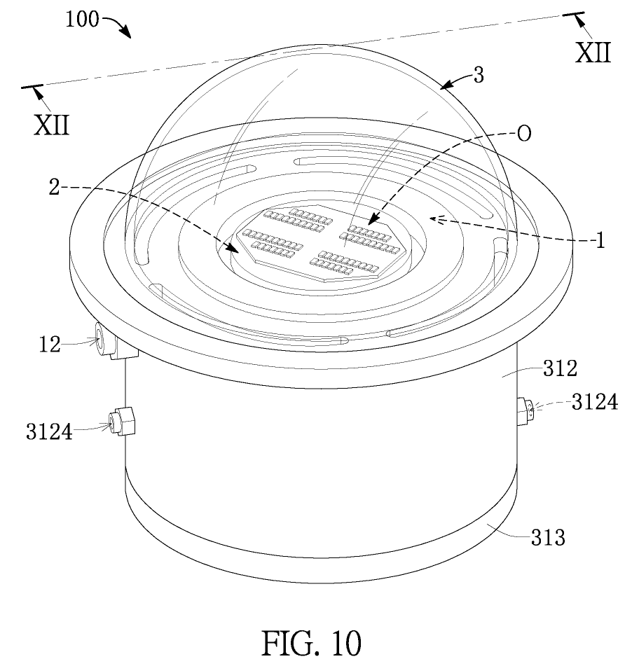

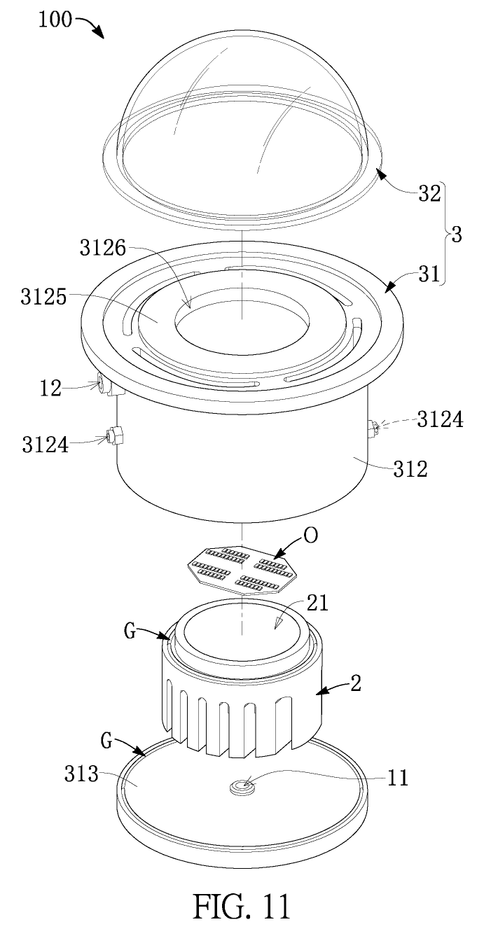

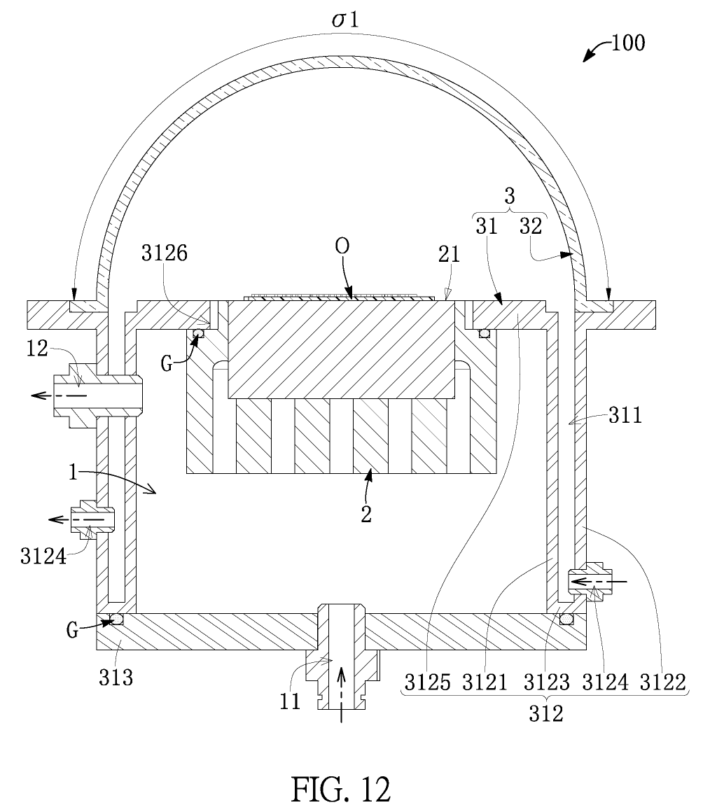

Referring to FIGS. 10 to FIG. 13, a third embodiment of the present disclosure, which is similar to the first embodiment of the present disclosure, is provided. For the sake of brevity, descriptions of the same components in the first and third embodiments of the present disclosure will be omitted herein, and the following description only discloses different features (e.g., the anti-condensation chamber 3 and connection relationship thereof) between the first and third embodiments.

As shown in FIGS. 10 to FIG. 12 of the present embodiment, the anti-condensation chamber 3 is configured to allow the DUT O on the carrying surface 21 to be located therein, and the environment simulation chamber 1 is covered by (or arranged in or enclosed within) and is not in spatial communication with the anti-condensation chamber 3. The environment simulation chamber 1 and the anti-condensation chamber 3 of the present embodiment are not in spatial communication with each other through the thermal conduction seat 2, but the present disclosure is not limited thereto.

The anti-condensation chamber 3 is configured to allow a dry air to travel therein, thereby effectively avoiding condensation of dew. In the present embodiment, the anti-condensation chamber 3 is configured to allow the dry air having a dew point temperature within a range from -130℃ to 10℃ to travel therein, and the dry air can have a normal temperature (e.g., 15℃ to 30℃), but the present disclosure is not limited thereto.

Specifically, the environment simulation chamber 1 in the present embodiment is defined by the anti-condensation chamber 3, and the thermal conduction seat 2 is arranged in the environment simulation chamber 1 by being assembled to the anti-condensation chamber 3. In order to clearly describe the present embodiment, the following description further describes one specific structure of the anti-condensation chamber 3 that can be provided to implement the one of the different configurations, but the present disclosure is not limited thereto.

Specifically, the anti-condensation chamber 3 includes a housing segment 31 and a light-permeable segment 32 that has a layer shape and that is connected to the housing segment 31. The structure and connection relationship of the housing segment 31 and the thermal conduction seat 2 in the present embodiment are substantially identical to those of the first embodiment (e.g., the heat transfer coefficient of the thermal conduction seat 2 being greater than or equal to 10W/m•k), but the annular wall 312 of the housing segment 31 of the present embodiment further includes a partition 3125 that is connected to the inner wall 3121 and that is arranged away from the end wall 3123.

Moreover, the partition 3125 is ring-shaped, and the partition 3125 has a hole 3126 arranged between the environment simulation chamber 1 and the anti-condensation chamber 3. The thermal conduction seat 2 abuts against the partition 3125 and closes the hole 3126, thereby spatially isolating the environment simulation chamber 1 and the anti-condensation chamber 3 from each other, and arranging the DUT O disposed on the carrying surface 21 to be located in the anti-condensation chamber 3, but the present disclosure is not limited thereto.

It should be noted that the temperature control device 100 further includes a plurality of gaskets G. Furthermore, one of the gaskets G is sandwiched between the partition 3125 of the annular wall 312 and the thermal conduction seat 2, and another one of the gaskets G is sandwiched between the end wall 3123 of the annular wall 312 and bottom base 313, thereby enabling the environment simulation chamber 1 to achieve a better airtight effect.

The light-permeable segment 32 in the present embodiment is a solid single-layer structure, and a space surroundingly defined by the light-permeable segment 32 is in spatial communication with the housing segment 31 (e.g., the inner space 311). The light-permeable segment 32 has a light transmittance within a range from 85% to 95% relative to light that has a wavelength within a range from 400 nm to 700 nm. For example, the light-permeable segment 32 can be made of glass (e.g., optical glass or quartz glass) or sapphire.

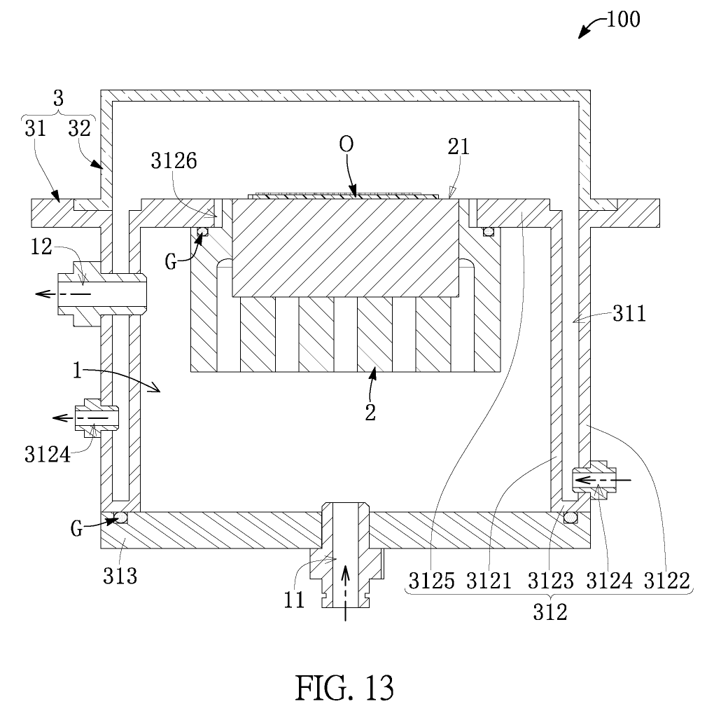

Specifically, in order to enable the light-permeable segment 32 to have better performance, the light-permeable segment 32 can have at least part of the following features. The light-permeable segment 32 has a spherical shape having a center of sphere that is located on the carrying surface 21. Moreover, in a cross section of the light-permeable segment 32, the light-permeable segment 32 has a first central angle σ1 being within a range from 0 degrees to 180 degrees, but the present disclosure is not limited thereto. For example, as shown in FIG. 13, the light-permeable segment 32 can have a flat layer structure.

In summary, the temperature control device 100 of the present embodiment is provided with the structural design and the cooperation of the environment simulation chamber 1, the thermal conduction seat 2, and the anti-condensation chamber 3, so that the anti-condensation chamber 3 can effectively prevent water vapor from condensing in a light source path of the DUT O, thereby allowing the energy of the light source emitted by the DUT O to pass through the light-permeable segment 32 for accurate measurement.

### Fourth Embodiment

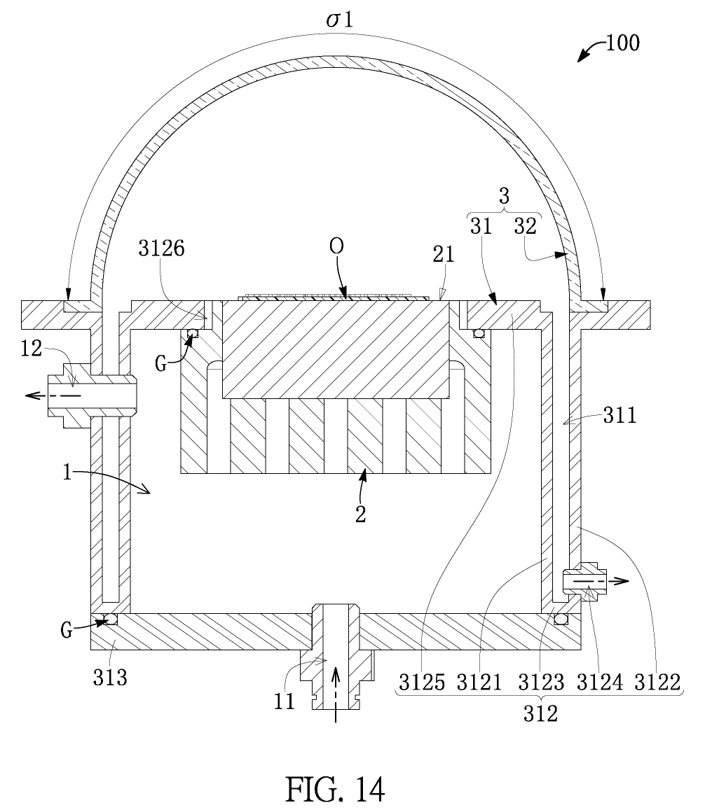

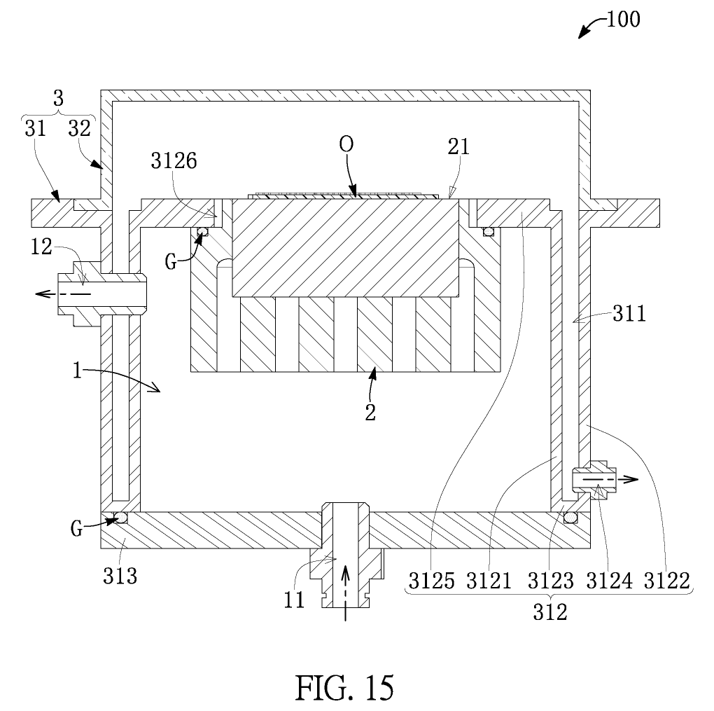

Referring to FIGS. 14 and FIG. 15, a fourth embodiment of the present disclosure, which is similar to the third embodiment of the present disclosure, is provided. For the sake of brevity, descriptions of the same components in the third and fourth embodiments of the present disclosure will be omitted herein, and the following description only discloses different features between the third and fourth embodiments.

In the present embodiment, the anti-condensation chamber 3 is in a vacuum mode (e.g., the anti-condensation chamber 3 having a pressure within a range from 10e-12 MPa~10e-5 MPa), thereby achieving an anti-condensation function. Specifically, the annular wall 312 (e.g., the outer wall 3122) can be formed with an entrance 3124 for suction of the anti-condensation chamber 3 therefrom, thereby meeting a vacuum requirement of the anti-condensation chamber 3.

### Beneficial Effects of the Embodiments

In conclusion, any one of the temperature control device and the photoelectric measurement apparatus of the present disclosure is provided with the structural design and the cooperation of the environment simulation chamber, the thermal conduction seat, and the anti-condensation chamber. As a result,, the anti-condensation chamber (e.g., the anti-condensation chamber being fully filled with the dry air or maintained in in the vacuum state) can effectively prevent water vapor from condensing along a light source path of the DUT, thereby allowing the energy of the light source emitted by the DUT to pass through the light-permeable segment for accurate measurement. In addition, the structural configuration of any one of the temperature control device and the photoelectric measurement apparatus also facilitates accurate measurement results in the high-temperature environments.

Furthermore, the temperature control device and the photoelectric measurement apparatus of the present disclosure are applicable to both high‑temperature and low‑temperature operating conditions. That is, the invention provides a wide temperature measurement range, for example, the temperature difference may span approximately 90 degrees, such as from a basic temperature range of 0 °C to 35 °C, can be further extended to 50 degrees (for example, −15 °C to 35 °C), further extended to about 150 degrees (−45 °C to 105 °C), and even extended to approximately 280 degrees (−55 °C to 280 °C).

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A temperature control device, comprising:
an environment simulation chamber that is configured to allow a cold air having temperature lower than 15℃ or a hot air having temperature higher than 35℃ to travel therein so as to simulate a low-temperature environment or a high-temperature environment;
a thermal conduction seat arranged in the environment simulation chamber and having a carrying surface that is configured to allow a device under test (DUT) to be disposed thereon so as to be located in the environment simulation chamber; and
an anti-condensation chamber configured to allow a dry air to travel therein, wherein the environment simulation chamber is covered by and is not in spatial communication with the anti-condensation chamber, and wherein the anti-condensation chamber includes:
a housing segment, wherein the thermal conduction seat is arranged in a space surroundingly defined by the housing segment; and
a light-permeable segment being in spatial communication with the housing segment and having an outer light-permeable layer and an inner light-permeable layer that is spaced apart from the outer light-permeable layer, wherein each of the outer light-permeable layer and the inner light-permeable layer has a spherical shape having a center of sphere that is located on the carrying surface.

2. The temperature control device according to claim 1, wherein the outer light-permeable layer has a first radius, and the inner light-permeable layer has a second radius that is less than or equal to 62% of the first radius.

3. The temperature control device according to claim 1, wherein the outer light-permeable layer has a first central angle being within a range from 0 degrees to 180 degrees, and the inner light-permeable layer has a second central angle that is greater than or equal to the first central angle.

4. The temperature control device according to claim 1, wherein the light-permeable segment is detachably assembled to the housing segment, and an inner side of the light-permeable segment and an inner side of the housing segment jointly define the environment simulation chamber.

5. The temperature control device according to claim 1, wherein the anti-condensation chamber is configured to allow a dry air having a dew point temperature within a range from -130℃ to 10℃ to travel therein, and wherein the anti-condensation chamber is in a vacuum mode having a pressure within a range from 10e-12 MPa to 10e-5 MPa.

6. A temperature control device, comprising:
an environment simulation chamber that is configured to allow a cold air having temperature lower than 15℃ or a hot air having temperature higher than 35℃ to travel therein so as to simulate a low-temperature environment or a high-temperature environment;
a thermal conduction seat arranged in the environment simulation chamber and having a carrying surface that is configured to allow a device under test (DUT) to be disposed thereon so as to be located in the environment simulation chamber; and
an anti-condensation chamber, wherein the environment simulation chamber is covered by and is not in spatial communication with the anti-condensation chamber, and wherein the anti-condensation chamber includes:
a housing segment, wherein the thermal conduction seat is arranged in a space surroundingly defined by the housing segment; and
a light-permeable segment being in spatial communication with the housing segment and having an outer light-permeable layer and an inner light-permeable layer that is spaced apart from the outer light-permeable layer, wherein the inner light-permeable layer is spaced apart from the carrying surface.

7. The temperature control device according to claim 6, wherein each of the outer light-permeable layer and the inner light-permeable layer has a flat layer structure.

8. The temperature control device according to claim 6, wherein the anti-condensation chamber is configured to allow a dry air having a dew point temperature within a range from -130℃ to 10℃ to travel therein, and wherein the anti-condensation chamber is in a vacuum mode having a pressure within a range from 10e-12 MPa to 10e-5 MPa.

9. The temperature control device according to claim 6, wherein the thermal conduction seat has a heat transfer coefficient being greater than or equal to 10W/m•k, and the light-permeable segment has a light transmittance within a range from 85% to 95% relative to light that has a wavelength within a range from 400 nm to 700 nm.

10. A temperature control device, comprising:
an environment simulation chamber that is configured to allow a cold air having temperature lower than 15℃ or a hot air having temperature higher than 35℃ to travel therein so as to simulate a low-temperature environment or a high-temperature environment;
a thermal conduction seat arranged in the environment simulation chamber and having a carrying surface that is configured to allow a device under test (DUT) to be disposed thereon so as to be located outside of the environment simulation chamber; and
an anti-condensation chamber configured to allow the DUT on the carrying surface to be located therein, wherein the environment simulation chamber is covered by and is not in spatial communication with the anti-condensation chamber, and wherein the anti-condensation chamber includes:
a housing segment, wherein the thermal conduction seat is arranged in a space surroundingly defined by the housing segment; and
a light-permeable segment having a layer shape and connected to the housing segment, wherein a space surroundingly defined by the light-permeable segment is in spatial communication with the housing segment.

11. The temperature control device according to claim 10, wherein the light-permeable segment has a spherical shape having a center of sphere that is located on the carrying surface.

12. The temperature control device according to claim 11, wherein the light-permeable segment has a first central angle being within a range from 0 degrees to 180 degrees.

13. The temperature control device according to claim 10, wherein the light-permeable segment has a flat layer structure.

14. The temperature control device according to claim 10, wherein the environment simulation chamber and the anti-condensation chamber are not in spatial communication with each other through the thermal conduction seat.

15. The temperature control device according to claim 10, wherein the anti-condensation chamber is configured to allow a dry air having a dew point temperature within a range from -130℃ to 10℃ to travel therein, and wherein the anti-condensation chamber is in a vacuum mode having a pressure within a range from 10e-12 MPa to 10e-5 MPa.

16. The temperature control device according to claim 10, wherein the thermal conduction seat has a heat transfer coefficient being greater than or equal to 10W/m•k, and the light-permeable segment has a light transmittance within a range from 85% to 95% relative to light that has a wavelength within a range from 400 nm to 700 nm.

17. A photoelectric measurement apparatus, comprising the temperature control device according to claim 1.

18. The photoelectric measurement apparatus according to claim 17, further being a total luminous flux measurement apparatus, a light intensity measurement apparatus, or a goniometer systems measurement apparatus.

19. The photoelectric measurement apparatus according to claim 18, further comprising:
an integral ball having an opening, wherein a part of the anti-condensation chamber of the temperature control device is inserted into the integral ball through the opening; and
a measurement device and an optical fiber, wherein the optical fiber is connected to the integral ball and the measurement device.

20. The photoelectric measurement according to claim 17, wherein the anti-condensation chamber is configured to allow a dry air having a dew point temperature within a range from -130℃ to 10℃ to travel therein, and wherein the anti-condensation chamber is in a vacuum mode having a pressure within a range from 10e-12 MPa to 10e-5 MPa.
